(19) United States
(12) Patent Application Publication
(10) Pub. No.: US 2026/0055553 A1
(43) Pub. Date: Feb. 26, 2026

(54) METHODS OF MAKING FILMS FROM PECTIN- AND PROTEIN-CONTAINING FEEDSTOCK AND FILMS MADE THEREBY

(71) Applicant: Auburn University, Auburn, AL (US)

(72) Inventors: Burak Aksoy, Auburn, AL (US); Zhihua Jiang, Auburn, AL (US)

(73) Assignee: Auburn University, Auburn, AL (US)

(21) Appl. No.: 19/102,653

(22) PCT Filed: Aug. 17, 2023
(86) PCT No.: PCT/US2023/030479

§ 371 Date: Feb. 10, 2025

Related U.S. Application Data
(60) Provisional application No. 63/399,054, filed on Aug. 18, 2022.

(51) Int. Cl. D21H 19/50; C08J 5/18; D21H 19/52; D21H 21/16; D21H 27/10

(52) U.S. Cl. CPC D21H 19/50; C08J 5/18; D21H 19/52; D21H 21/16; D21H 27/10; C08J 2305/06; C08J 2489/00

(57) ABSTRACT

Methods of making films with feedstock comprising biomass. The methods include treating a feedstock comprising biomass with an acidic aqueous solution to yield a solid phase and a liquor, generating a forming fluid with the liquor, and generating a film from the forming fluid. Some versions include comminuting the solid phase to generate a comminuted solid phase and including the comminuted solid phase in the forming fluid. The biomass preferably contains relatively high amounts of pectin and protein. The films can be in the form of standalone films or coatings on substrates such as paper. The films provide oil and grease resistance and air impermeability, among other advantages.

### CROSS-REFERENCE TO RELATED APPLICATIONS

Priority is hereby claimed to U.S. Application 63/399,054, filed Aug. 18, 2022, which is incorporated herein by reference in its entirety.

### FIELD OF THE INVENTION

The invention is directed to methods of making films from pectin- and protein-containing feedstock, films made thereby, and coated products made with or containing the films.

### BACKGROUND

Greaseproof paper is impermeable to grease and oil and can be an economical and adaptable solution for wrapping a wide range of food for packaging and cooking. Generally, the paper is created by refining paper pulp into a sheet with minimum porosity. In addition, density can be improved by treating the paper with starch and other chemicals to enhance its resistance to grease.

Several greaseproof paper products are on the market from many manufacturers and are generally segmented into butter paper, waxed paper, and baking paper. Butter paper is comprised of cellulose, does not have a non-stick surface, and is used for packaging and wrapping fatty and moist food. Waxed paper is coated with wax and has a non-stick and water-resistant surface. Baking or parchment paper is a greaseproof paper used for baking and cooking.

Though parchmentized paper and highly refined greaseproof paper products are widely used, they have been substantially displaced by oil-repellent fluorocarbon treatments of paper. The fluorocarbons used in these treatments include per- and poly-fluoroalkyl substances (PFAS). The fluorocarbon treatments allow papermakers to achieve greaseproof properties with ordinary paper machine equipment at typical refining levels without immersing the paper in strong acid. The greaseproof papers made with fluorocarbons, however, have been associated with health concerns, especially when the papers encounter food. In addition, the harmful fluorocarbons have been found in sludge from municipal wastewater treatment. Greaseproof paper products also face cost pressures, threatening their ability to compete against alternative materials such as polyethylene films. Greaseproof films that can serve as options for greaseproof paper products and address the foregoing problems are needed.

### SUMMARY OF THE INVENTION

One aspect of the invention is directed methods of making films. In some versions, the methods comprise treating a feedstock comprising pectin-containing and protein-containing biomass with an aqueous acidic solution at a pH, at a temperature, and for a time sufficient to yield a mixture containing a solid phase comprising biomass solids and a liquor in liquid phase comprising partially dissolved biomass, wherein acid within the aqueous acidic solution is added exogenously or is formed in situ; generating a forming fluid with the liquor; and generating the film from the forming fluid.

In some versions, the biomass comprises at least 4% w/w pectin.

In some versions, the biomass comprises at least 5% w/w protein.

In some versions, the biomass comprises less than 10% w/w lignin.

In some versions, the biomass comprises soybean-hull biomass, fruit or vegetable pomace, sugar beet pulp, citrus biomass, rapeseed biomass, or any combination thereof.

In some versions, the biomass is in particle form having a US mesh size of 8 or finer. In some versions, the pH is from 1 to 5.

In some versions, the temperature is from 65° C. to 100° C.

In some versions, the time is at least 20 minutes.

In some versions, generating the forming fluid comprises separating the liquor from the solid phase to generate a separated liquor and generating the forming fluid with the separated liquor. In some versions, the forming fluid comprises the separated liquor in an amount of at least 40% w/w.

In some versions, generating the forming fluid comprises comminuting the solid phase to generate a comminuted solid phase and including the comminuted solid phase in the forming fluid. In some versions, the generating the forming fluid comprises comminuting the solid phase in the mixture to generate a comminuted mixture and generating the forming fluid with the comminuted mixture. In some versions, the forming fluid comprises the comminuted mixture in an amount of at least 20% w/w.

In some versions, generating the film comprises generating a standalone film. In some versions, the film has a grammage of from 30 g/m² to 600 g/m².

In some versions, generating the film comprises coating a substrate with the forming fluid to generate a coated substrate. In some versions, the film has a grammage of from 4 g/m² to 30 g/m². In some versions, the substrate comprises paper such that the coated substrate is coated paper. In some versions, the paper prior to the coating has a TAPPI T 559 Kit Number less than 6. In some versions, the coated paper has a TAPPI T 559 Kit Number greater than 6.

In some versions, the film has an air permeability value greater than 200 s/100 mL. In some versions, the film is air impermeable.

Another aspect of the invention is directed to coated substrates made from the methods of the invention.

Another aspect of the invention is directed to films made from the methods of the invention.

The objects and advantages of the invention will appear more fully from the following detailed description of the preferred embodiment of the invention made in conjunction with the accompanying drawings.

### BRIEF DESCRIPTION OF THE DRAWINGS

FIG. 1. Burst index comparison of exemplary uncoated and coated sheets. Statistical analysis was performed and statistically significant differences are indicated.

FIG. 2. Folding endurance comparison of exemplary uncoated and coated sheets. Statistical analysis was performed and statistically significant differences are indicated.

FIG. 3. Air permeability comparison of exemplary uncoated and coated sheets. Statistical analysis was performed and statistically significant differences are indicated. The depicted units of ml/min is the inverse of the units sec/100 mL as described elsewhere herein.

FIG. 4. Tensile index comparison of exemplary uncoated and coated sheets. Statistical analysis was performed and statistically significant differences are indicated.

FIG. 5. Tensile energy to break (toughness) comparison of exemplary uncoated and coated sheets. Statistical analysis was performed and statistically significant differences are indicated.

### DETAILED DESCRIPTION OF THE INVENTION

One aspect of the invention is directed to making films. The films of the invention are generally in the form of sheets having a first surface, a second surface, and a depth between the first and second surfaces. The films can be planar or embody curvature. In some versions, the films are in the form of a coating, in which the film is adhered to a substrate. The coating can be adhered to the substrate along one of the surfaces. In some versions, the films are in the form of a standalone film, in which the film is not adhered to a substrate.

The methods of making the films can comprise treating a feedstock comprising biomass with an aqueous acidic solution.

For the purposes herein, “biomass” refers to the organic materials produced by plants and animals, such as cobs, husks, leaves, roots, seeds, shells, and stalks, as well as microbial and animal metabolic wastes (e.g., manure), without limitation. Common sources of biomass include (without limitation): agricultural wastes, such as corn cobs and stalks, straw, seed hulls, sugarcane leavings, bagasse, nutshells, citrus peels, fruit and vegetable skins, egg shells, and manure from cattle, poultry, and hogs; woody materials, such as wood or bark, sawdust, timber slash, and mill scrap; municipal waste, such as waste paper and yard clippings; energy crops, such as poplars, willows, switch grass, alfalfa, prairie bluestem, corn, soybean; and peat moss, and the like.

It was found that biomass with relatively high amounts of pectin confers beneficial properties to the films made therefrom, including oil and grease resistance and other properties. Accordingly, in various versions of the invention, the biomass comprises pectin in amount of at least 1% w/w, at least 2% w/w, at least 3% w/w, at least 4% w/w, at least 5% w/w, at least 7.5% w/w, at least 10% w/w, at least 12.5% w/w, at least 15% w/w, at least 20% w/w, at least 22.5% w/w, at least 25% w/w, at least 30% w/w, or more. Such amounts are understood to be determined with respect to the dry weight of the biomass.

It was found that biomass with relatively high amounts of protein confers beneficial properties to the films made therefrom, including oil and grease resistance and other properties. Accordingly, in some versions of the invention, the biomass comprises protein in amount of at least 1% w/w, at least 2% w/w, at least 3% w/w, at least 4% w/w, at least 5% w/w, at least 7.5% w/w, at least 10% w/w, at least 12.5% w/w, at least 15% w/w, at least 20% w/w, at least 22.5% w/w, at least 25% w/w, at least 30% w/w, or more. Such amounts are understood to be determined with respect to the dry weight of the biomass.

It was found that biomass with relatively low amounts of lignin confers beneficial properties to the films made therefrom, including oil and grease resistance and other properties. Accordingly, in some versions of the invention, the biomass comprises lignin in an amount less than 25% w/w, less than 20% w/w, less than 15% w/w, less than 10% w/w, less than 9% w/w, less than 8% w/w, less than 7% w/w, less than 6% w/w, less than 5% w/w, less than 4% w/w, less than 3% w/w, less than 2% w/w, less than 1% w/w, less than 0.5% w/w, or less than 0.1% w/w. Such amounts are understood to be determined with respect to the dry weight of the biomass. “Comprising less” than a given amount of lignin in this context encompasses being completely devoid of lignin.

Examples of biomass comprising relative high amounts of pectin and protein and relatively low amounts of lignin include soybean-hull biomass (e.g., whole soybean hulls or comminuted forms thereof), fruit or vegetable pomace (for example, from apples, passion fruit, olives, grapes, etc.), sugar beet pulp, citrus biomass such as citrus waste and citrus peel, and rapeseed biomass such as rapeseed cake and rapeseed meal (M. C. Edwards, J. Doran-Peterson Pectin-rich biomass as feedstock for fuel ethanol production Appl. Microbiol. Biotechnol., 95 (2012), pp. 565-575).

The biomass can be in whole, raw form or a processed form. The processed forms can include enzymatically processed forms, chemically processed forms, and physically processed forms. The physically processed forms include comminuted forms. The comminution of the biomass can be conducted by any suitable method, including grinding and milling. Milling may be performed using, for example, a hammer mill, ball mill, colloid mill, conical or cone mill, disk mill, edge mill, Wiley mill, grist mill, or other mill. Grinding may be performed using, for example, a cutting/impact type grinder. Some exemplary grinders include stone grinders, pin grinders, coffee grinders, and burr grinders. Grinding or milling may be provided, for example, by a reciprocating pin or other element, as is the case in a pin mill. Other comminution methods include mechanical ripping or tearing, other methods that apply pressure to the fibers, and air attrition milling.

In some versions, the biomass is in a comminuted form having a US mesh size of 1 or finer, 2 or finer, 3 or finer, 4 or finer, 5 or finer, 6 or finer, 7 or finer, 8 or finer, 9 or finer, or 10 or finer. In some versions, the biomass is comminuted to a micro or nano scale.

“Aqueous solution” in “aqueous acidic solution” refers to a solution comprising water in an amount of at least 50% w/w, such as at least about 55% w/w, at least about 60 w/w, at least about 65% w/w, at least about 70% w/w, at least about 75% w/w, at least about 80% w/w, at least about 85% w/w, at least about 90% w/w, at least about 95% w/w, at least about 97% w/w, or at least about 99% w/w.

“Acidic” in “aqueous acidic solution” refers to having a pH less than 7. In various versions, the aqueous acidic solution has a pH less than 6.5, less than 6, less than 5.5, less than 5, less than 4.5, less than 4, or less than 3.5. In various versions, the aqueous acidic solution has a pH of at least 1, at least 1.5, at least 2, or at least 2.5. In some versions, the aqueous acidic solution has a pH in a range of 1-5, 1.5-4.5, 2-4, 2.5-3.5, or about 3.

The acid within the aqueous acidic solution can be added exogenously or can be formed in situ. In situ formation of the acid can be obtained (depending on the type of biomass feedstock), by heating the biomass feedstock in aqueous solution at a temperature and for a time sufficient to release organic acids from biomass feedstock. Exemplary acids that can be added include, without limitation, mineral and organic acids. Common mineral acids include, without limitation, hydrochloric acid, sulfuric acid, nitric acid, and the like. Common organic acids include, without limitation, lactic acid, acetic acid, formic acid, citric acid, oxalic acid, uric acid, malic acid, etc.

The biomass feedstock in the methods of the invention is preferably treated with the aqueous acidic solution at a pH, at a temperature, and for a time sufficient to at least partially dissolve the biomass in the solution to thereby yield a solid phase comprising biomass solids and a liquid phase comprising partially dissolved biomass. The liquid phase comprising the partially dissolved biomass is referred to herein as a “liquor.” The biomass dissolved in solution can be any component of the biomass feedstock. The biomass dissolved in solution preferably comprises pectin and protein. The biomass feedstock in some versions is treated under conditions effective to result in the liquor comprising dissolved pectin in an amount of at least about 1% w/v, at least about 2% w/v, at least about 3% w/v, at least about 4% w/v, at least about 5% w/v, at least about 6% w/v, at least about 7% w/v, at least about 8% w/v, at least about 9% w/v, at least about 10% w/v, at least about 15% w/v, at least about 20% w/v, at least about 25% w/v, at least about 30% w/v, at least about 35% w/v, at least about 40% w/v, at least about 45% w/v, or at least about 50% w/v of the liquor. The biomass feedstock in some versions is treated under conditions effective to result in the liquor comprising dissolved protein in an amount of at least about 1% w/v, at least about 2% w/v, at least about 3% w/v, at least about 4% w/v, at least about 5% w/v, at least about 6% w/v, at least about 7% w/v, at least about 8% w/v, at least about 9% w/v, at least about 10% w/v, at least about 15% w/v, at least about 20% w/v, at least about 25% w/v, at least about 30% w/v, at least about 35% w/v, at least about 40% w/v, at least about 45% w/v, or at least about 50% w/v of the liquor. In some versions, such amounts are present in the liquor after the treating and prior to drying. In some versions, such amounts or higher are present in the liquor after the treating and drying, as much of the liquor prior to any processing is water that can be evaporated.

The pH of the aqueous acidic solution in the treating, as is consistent with the solution being acidic, is less than 7. In various versions, the aqueous acidic solution, as outlined above, has a pH less than 6.5, less than 6, less than 5.5, less than 5, less than 4.5, less than 4, or less than 3.5. In various versions, the aqueous acidic solution has a pH of at least 1, at least 1.5, at least 2, or at least 2.5. In some versions, the aqueous acidic solution has a pH in a range of 1-5, 1.5-4.5, 2-4, 2.5-3.5, or about 3. It is understood that any of the foregoing pHs (or ranges thereof) will be maintained throughout a given time (or range thereof) and temperature (or range thereof) of treatment.

The temperature of the treatment can be any temperature effective to at least partially dissolve the biomass in the aqueous acidic solution. In various versions, the temperature can be at least 40° C., at least 45° C., at least 50° C., at least 55° C., at least 60° C., at least 65° C., at least 70° C., at least 75° C., at least 85° C., or at least 90° C. In some versions, the temperature can be up to 100° C., up to 105° C., up to 110° C., up to 115° C., up to 120° C., up to 125° C., up to 130° C., up to 135° C., up to 140° C., up to 145° C., up to 150° C., or more. In various versions, the temperature is in a range of 40-150° C., 65-125° C., 70-120° C., 75-115° C., 80-110° C., 85-105° C., 90-100° C., 40-100° C., 45-100° C., 50-100° C., 50-100° C., 55-100° C., 60-100° C., 65-100° C., 70-100° C., 75-100° C., 80-100° C., 85-100° C., 90-100° C., or about 95° C. It is understood that any of the foregoing temperatures (or ranges thereof) will be maintained throughout a given time (or range thereof) and pH (or range thereof) of treatment. In some versions, the temperature is employed at a pressure of 1 atm. In some versions, higher temperatures (e.g., 100° C. and higher) are employed at elevated pressures (e.g., greater than 1 atm).

The time of the treatment can be any time effective to at least partially dissolve the biomass in the aqueous acidic solution. In various versions, the time can be at least 5 minutes, at least 10 minutes, at least 15 minutes, at least 20 minutes, at least 25 minutes, at least 30 minutes, at least 35 minutes, at least 40 minutes, at least 50 minutes, or at least 55 minutes. In some versions, the time can be up to 65 minutes, up to 70 minutes, up to 80 minutes, up to 90 minutes, up to 100 minutes up to 125 minutes, up to 150 minutes or more. It is understood a given time (or range thereof) and pH (or range thereof) will be maintained throughout the treatment for any of the foregoing times (or ranges thereof).

The treating can be conducted at a pressure of 1 atm or higher. The treating in the following examples was performed at 1 atm.

The methods of making the films of the invention can also comprise generating a forming fluid with the liquor. “Forming fluid” as used herein refers to a fluid used to generate a film, as described in further detail below. The forming fluid can comprise, consist, or consist essentially of the liquor as generated in the treatment and/or can comprise, consist, or consist essentially of a processed (chemically, physically, etc.) form of the liquor and/or mixture.

In some versions, generating the forming fluid can comprise separating the liquor from the solid phase to generate a separated liquor and generating the forming fluid with the separated liquor. “Generating the forming fluid with the separated liquor” in this context can encompass using the separated liquor as-is as the forming fluid or mixing the separated liquor with other components (such as the comminuted mixture as described below) to arrive at the forming fluid. Any method suitable for separating solid phases from liquid phases can be used in the separation, including filtration and centrifugation, among other methods.

In various versions, the forming fluid comprises the separated liquor in an amount of at least 1% w/w, at least 5% w/w, at least 10% w/w, at least 15% w/w, at least 20% w/w, at least 25% w/w, at least 30% w/w, at least 35% w/w, at least 40% w/w, at least 45% w/w, at least 50% w/w, at least 55% w/w, at least 60% w/w, at least 65% w/w, at least 70% w/w, at least 75% w/w, at least 80% w/w, at least 85% w/w, at least 90% w/w, at least 95% w/w, at least 99% w/w, or 100% w/w. In various versions, the forming fluid comprises the separated liquor in an amount up to 1% w/w, up to 5% w/w, up to 10% w/w, up to 15% w/w, up to 20% w/w, up to 25% w/w, up to 30% w/w, up to 35% w/w, up to 40% w/w, up to 45% w/w, up to 50% w/w, up to 55% w/w, up to 60% w/w, up to 65% w/w, up to 70% w/w, up to 75% w/w, up to 80% w/w, up to 85% w/w, up to 90% w/w, up to 95% w/w, up to 99% w/w, or 100% w/w.

In some versions, generating the forming fluid can comprise comminuting the solid phase to generate a comminuted solid phase and including the comminuted solid phase in the forming fluid. As described in further detail below, the solid phase can be comminuted with or without the presence of the liquor. “Comminuting” as used herein refers to the processing of a solid starting material into multiple fragments of a smaller size. Comminuting can be performed by crushing, cutting, vibrating, microfluidizing, or other processes. In some versions, the comminuting comprises microfluidizing the solid phase. The microfluidizing can be performed with a microfluidizer to fibrillate the solid phase. The microfluidizing can be performed with a microfibrillation processor, such as a homogenizer, microfluidizer, super mass collider, sonicator, cyrocrushing, modified refiners, etc. In some versions, the solid phase can be comminuted to a micro or nano scale.

In various versions of the invention, at least 50%, at least 55%, at least 65%, at least 70%, at least 75%, at least 80%, at least 85%, at least 90%, at least 95%, or at least 99% by number of the comminuted solids in the comminuted solid phase have a diameter (whether particle, fiber, or combination thereof) less than 500 μm, less than 400 μm, less than 300 μm, less than 200 μm, less than 100 μm, less than 1 μm, less than 900 nm, less than 800 nm, less than 700 nm, less than 600 nm, less than 500 nm, less than 400 nm, less than 300 nm, less than 200 nm, or less than 100 nm. Any given embodiment of the invention can include any one of the foregoing % numbers in combination with any one of the foregoing maximum diameters.

In various versions, the forming fluid comprises the comminuted solid phase in an amount of at least 1% w/w, at least 5% w/w, at least 10% w/w, at least 15% w/w, at least 20% w/w, at least 25% w/w, at least 30% w/w, at least 35% w/w, at least 40% w/w, at least 45% w/w, at least 50% w/w, at least 55% w/w, at least 60% w/w, at least 65% w/w, at least 70% w/w, at least 75% w/w, at least 80% w/w, at least 85% w/w, at least 90% w/w, at least 95% w/w, at least 99% w/w, or 100% w/w. In various versions, the forming fluid comprises the comminuted solid phase in an amount up to 1% w/w, up to 5% w/w, up to 10% w/w, up to 15% w/w, up to 20% w/w, up to 25% w/w, up to 30% w/w, up to 35% w/w, up to 40% w/w, up to 45% w/w, up to 50% w/w, up to 55% w/w, up to 60% w/w, up to 65% w/w, up to 70% w/w, up to 75% w/w, up to 80% w/w, up to 85% w/w, up to 90% w/w, up to 95% w/w, up to 99% w/w, or 100% w/w.

In some versions, generating the forming fluid can comprise comminuting the solid phase in the mixture (i.e., in combination with the liquor) to generate a comminuted mixture and generating the forming fluid with the comminuted mixture. “Generating the forming fluid with the comminuted mixture” in this context can encompass using the comminuted mixture as-is as the forming fluid or mixing the comminuted mixture with other components (such as the separated liquor as described above) to arrive at the forming fluid. The comminuting can be performed using any suitable process, including those described above.

In various versions of the invention, at least 50%, at least 55%, at least 65%, at least 70%, at least 75%, at least 80%, at least 85%, at least 90%, at least 95%, or at least 99% by number of the comminuted solids in the comminuted mixture have a diameter (whether particle, fiber, or combination thereof) less than 500 μm, less than 400 μm, less than 300 μm, less than 200 μm, less than 100 μm, less than 1 μm, less than 900 nm, less than 800 nm, less than 700 nm, less than 600 nm, less than 500 nm, less than 400 nm, less than 300 nm, less than 200 nm, or less than 100 nm. Any given embodiment of the invention can include any one of the foregoing % numbers in combination with any one of the foregoing maximum diameters.

In various versions, the forming fluid comprises the comminuted mixture in an amount of at least 1% w/w, at least 5% w/w, at least 10% w/w, at least 15% w/w, at least 20% w/w, at least 25% w/w, at least 30% w/w, at least 35% w/w, at least 40% w/w, at least 45% w/w, at least 50% w/w, at least 55% w/w, at least 60% w/w, at least 65% w/w, at least 70% w/w, at least 75% w/w, at least 80% w/w, at least 85% w/w, at least 90% w/w, at least 95% w/w, at least 99% w/w, or 100% w/w. In various versions, the forming fluid comprises the comminuted mixture in an amount up to 1% w/w, up to 5% w/w, up to 10% w/w, up to 15% w/w, up to 20% w/w, up to 25% w/w, up to 30% w/w, up to 35% w/w, up to 40% w/w, up to 45% w/w, up to 50% w/w, up to 55% w/w, up to 60% w/w, up to 65% w/w, up to 70% w/w, up to 75% w/w, up to 80% w/w, up to 85% w/w, up to 90% w/w, up to 95% w/w, up to 99% w/w, or 100% w/w.

In various versions of the invention, the forming fluid comprises the separated liquor and the comminuted mixture in a ratio by weight of 99:1 (separated liquor:comminuted mixture), 95:5 (separated liquor:comminuted mixture), 90:10 (separated liquor:comminuted mixture), 85:15 (separated liquor:comminuted mixture), 80:20 (separated liquor:comminuted mixture), 75:25 (separated liquor:comminuted mixture), 70:30 (separated liquor:comminuted mixture), 65:35 (separated liquor:comminuted mixture), 60:40 (separated liquor:comminuted mixture), 55:45 (separated liquor:comminuted mixture), 50:50 (separated liquor:comminuted mixture), 45:55 (separated liquor:comminuted mixture), 40:60 (separated liquor:comminuted mixture), 35:65 (separated liquor:comminuted mixture), 30:70 (separated liquor:comminuted mixture), 25:75 (separated liquor:comminuted mixture), 20:80 (separated liquor:comminuted mixture), 15:85 (separated liquor:comminuted mixture), 10:90 (separated liquor:comminuted mixture), 5:95 (separated liquor:comminuted mixture), 1:99 (separated liquor:comminuted mixture), or any range between and including any two of the foregoing ratios.

In some versions, generating the forming fluid can comprise separating the liquor from the solid phase to generate a separated liquor and a separated solid phase, comminuting the separated solid phase to generate a comminuted separated solid phase, and including the comminuted separated solid phase in the forming fluid. The comminuting can be performed using any suitable process, including those described above.

In various versions of the invention, at least 50%, at least 55%, at least 65%, at least 70%, at least 75%, at least 80%, at least 85%, at least 90%, at least 95%, or at least 99% by number of the comminuted solids in the comminuted separated solid phase have a diameter (whether particle, fiber, or combination thereof) less than 500 μm, less than 400 μm, less than 300 μm, less than 200 μm, less than 100 μm, less than 1 μm, less than 900 nm, less than 800 nm, less than 700 nm, less than 600 nm, less than 500 nm, less than 400 nm, less than 300 nm, less than 200 nm, or less than 100 nm. Any given embodiment of the invention can include any one of the foregoing % numbers in combination with any one of the foregoing maximum diameters.

In various versions, the forming fluid comprises the comminuted separated solid phase in an amount of at least 1% w/w, at least 5% w/w, at least 10% w/w, at least 15% w/w, at least 20% w/w, at least 25% w/w, at least 30% w/w, at least 35% w/w, at least 40% w/w, at least 45% w/w, or at least 50% w/w. In various versions, the forming fluid comprises the comminuted separated solid phase in an amount up to 1% w/w, up to 5% w/w, up to 10% w/w, up to 15% w/w, up to 20% w/w, up to 25% w/w, up to 30% w/w, up to 35% w/w, up to 40% w/w, up to 45% w/w, up to 50% w/w, up to 55% w/w, up to 60% w/w, or more.

The methods of making the films of the invention can also comprise generating the film from the forming fluid.

In some versions, generating the film comprises generating a standalone film. A standalone film can be made by placing the forming fluid in a mold, drying the forming fluid while in the mold, and removing the dried forming fluid from the mold to thereby obtain the standalone film. In various versions, the standalone film has grammage of at least 10 g/m², at least 20 g/m², at least 30 g/m², at least 40 g/m², at least 50 g/m², at least 60 g/m², at least 70 g/m², at least 80 g/m², at least 90 g/m², or at least 100 g/m². In various versions, the standalone film has a grammage of up to 200 g/m², up to 300 g/m², up to 400 g/m², up to 500 g/m², up to 600 g/m², or more. “Grammage” as used herein is as used in the art, which is the weight of a substance per unit area. For the films of the invention, the area is defined as the area of either the first or the second surface, whichever is greater.

In some versions, generating the film comprises generating a coating. In some versions, the coating can be made by coating a substrate with the forming fluid and drying the forming fluid. In some versions, the coating can be made by generating a standalone film and then adhering the standalone film to the substrate. The substrate with the film coated thereon is referred to herein as a coated substrate.

The substrate can comprise any material to which the film adheres. In some versions, the substrate is a hydrophilic substrate.

In some versions, the substrate is paper. Paper, as is known in the art, comprises sheet material comprised of cellulose fibers and other materials. For the purposes herein, the term refers to both thin, flexible cellulosic sheet material (e.g., printer paper, toilette paper, ruled paper) as well as thicker, stiffer cellulosic sheet material such as cardboards (e.g., paperboard, fiberboard), egg boxes, etc. The films can be planar or embody curvature (as with egg boxes). Beyond cellulose fibers, the paper can include any other component now known or developed in the future and can be made using any method now known or developed in the future.

In various versions of the invention, the film on the substrate has a grammage of at least 1 g/m², at least 2 g/m², at least 3 g/m², at least 4 g/m², at least 5 g/m², at least 6 g/m², at least 7 g/m², at least 8 g/m², at least 9 g/m², at least 10 g/m², at least 11 g/m², at least 12 g/m², at least 13 g/m², at least 14 g/m², at least 15 g/m², at least 16 g/m², at least 17 g/m², at least 18 g/m², at least 19 g/m², at least 20 g/m², at least 30 g/m², at least 40 g/m², at least 50 g/m², at least 60 g/m², at least 70 g/m², at least 80 g/m², at least 90 g/m², or at least 100 g/m². In various versions of the invention, the film on the substrate has a grammage up to 9 g/m², up to 10 g/m², up to 11 g/m², up to 12 g/m², up to 13 g/m², up to 14 g/m², up to 15 g/m², up to 16 g/m², up to 17 g/m², up to 18 g/m², up to 19 g/m², up to 20 g/m², up to 30 g/m², up to 40 g/m², up to 50 g/m², up to 60 g/m², up to 70 g/m², up to 80 g/m², up to 90 g/m², up to 100 g/m², or more. In some versions, the film on the substrate has a grammage in a range of 4-15 g/m², such as 8-15 g/m².

The films of the invention have oil and grease resistance, whether in standalone form or in the form of coatings. The films of the invention can thereby increase the oil and grease resistance of substrates on which it is coated. In various versions, the substrate without the film coated thereon has a TAPPI T559 Kit Number less than 12, less than 11.5, less than 11, less than 10.5, less than 10, less than 9.5, less than 9, less than 8.5, less than 8, less than 7.5, less than 7, less than 6.5, less than 6, less than 5.5, less than 5, less than 4.5, less than 4, less than 3.5, less than 3, less than 2.5, less than 2, less than 1.5, less than 1, less than 0.5, less than 0.1, or 0 In various versions, the substrate with the film coated thereon has a TAPPI T559 Kit Number greater than 0, greater than 0.5, greater than 1, greater than 1.5, greater than 2, greater than 2.5, greater than 3, greater than 3.5, greater than 4, greater than 4.5, greater than 5, greater than 5.5, greater than 6, greater than 6.5, greater than 7, greater than 7.5, greater than 8, greater than 8.5, greater than 9, greater than 9.5, greater than 10, greater than 10.5, greater than 11, greater than 11.5, or 12. The TAPPI T559 Kit Number is determined according to the TAPPI T 559 cm-22 test, as is well known in the art (world wide web at imisrise.tappi.org/TAPPI/Products/01/T/0104T559.aspx). In various versions of the invention, the film on the substrate conferring such an effect can have any of the grammages described above or elsewhere herein.

In various versions of the invention, the films of the invention confer a difference in TAPPI T559 Kit Numbers between the coated substrate relative to the uncoated substrate of at least 0.5, at least 1, at least 1.5, at least 2, at least 2.5, at least 3, at least 3.5, at least 4, at least 4.5, at least 5, at least 5.5, at least 6, at least 6.5, at least 7, at least 7.5, at least 8, at least 8.5, at least 9, at least 9.5, at least 10, at least 10.5, at least 11, at least 11.5, or 12. In various versions of the invention, the film on the substrate conferring such an effect can have any of the grammages described above or elsewhere herein.

In various versions, the films (either the coatings or the standalone films) of the invention have a TAPPI T559 Kit Number greater than 0, greater than 0.5, greater than 1, greater than 1.5, greater than 2, greater than 2.5, greater than 3, greater than 3.5, greater than 4, greater than 4.5, greater than 5, greater than 5.5, greater than 6, greater than 6.5, greater than 7, greater than 7.5, greater than 8, greater than 8.5, greater than 9, greater than 9.5, greater than 10, greater than 10.5, greater than 11, greater than 11.5, or 12. In various versions of the invention, such films can have any of the grammages described above or elsewhere herein.

The films and/or coated substrates of the invention have a low degree of air impermeability or are impermeable. In some versions, the films and/or coated substrates of the invention have an air permeability value greater than 30 sec/100 mL, greater than 40 sec/100 mL, greater than 50 sec/100 mL, greater than 60 sec/100 mL, greater than 70 sec/100 mL, greater than 80 sec/100 mL, greater than 90 sec/100 mL, greater than 100 sec/100 mL, greater than 110 sec/100 mL, greater than 120 sec/100 mL, greater than 130 sec/100 mL, greater than 140 sec/100 mL, greater than 150 sec/100 mL, greater than 175 sec/100 mL, greater than 200 sec/100 mL, greater than 225 sec/100 mL, greater than 250 sec/100 mL, greater than 275 sec/100 mL, greater than 300 sec/100 mL, greater than 400 sec/100 mL, greater than 500 sec/100 mL, greater than 600 sec/100 mL, greater than 700 sec/100 mL, greater than 800 sec/100 mL, greater than 900 sec/100 mL, greater than 1,000 sec/100 mL, greater than 2,000 sec/100 mL, greater than 3,000 sec/100 mL, greater than 4,000 sec/100 mL, greater than 5,000 sec/100 mL, greater than 6,000 sec/100 mL, greater than 7,000 sec/100 mL, greater than 8,000 sec/100 mL, greater than 9,000 sec/100 mL, or greater than 10,000 sec/100 mL. In some versions, the films and/or coated substrates of the invention are air impermeable. Air impermeability is considered to be encompassed by all of the foregoing air permeability values. In various versions, the films and/or coated substrates of the invention have an air permeability value of up to 40 sec/100 mL, up to 50 sec/100 mL, up to 60 sec/100 mL, up to 70 sec/100 mL, up to 80 sec/100 mL, up to 90 sec/100 mL, up to 100 sec/100 mL, up to 110 sec/100 mL, up to 120 sec/100 mL, up to 120 sec/100 mL, up to 120 sec/100 mL, up to 120 sec/100 mL, up to 130 sec/100 mL, up to 140 sec/150 mL, up to 175 sec/100 mL, up to 200 sec/100 mL, up to 225 sec/100 mL, up to 250 sec/100 mL, up to 275 sec/100 mL, up to 300 sec/100 mL, up to 350 sec/100 mL, up to 375 sec/100 mL, up to 400 sec/100 mL, up to 500 sec/100 mL, up to 600 sec/100 mL, up to 700 sec/100 mL, up to 800 sec/100 mL, up to 900 sec/100 mL, up to 1,000 sec/100 mL, up to 2,000 sec/100 mL, up to 3,000 sec/100 mL, up to 4,000 sec/100 mL, up to 5,000 sec/100 mL, up to 6,000 sec/100 mL, up to 7,000 sec/100 mL, up to 8,000 sec/100 mL, up to 9,000 sec/100 mL, up to 10,000 sec/100 mL, up to 15,000 sec/mL, or more. Such values for air permeability are determined according to the TAPPI Test Method T 460 om-21 (Gurley method) for determining the air resistance of paper (world wide web at imisrise.tappi.org/TAPPI/Products/01/T/0104T460.aspx). Air impermeability is defined as undetectable air permeability (0 ml/min) over 60 minutes using the TAPPI Test Method T 460 om-21 (Gurley method). In various versions of the invention, the film on the substrate conferring such an effect can have any of the grammages described above or elsewhere herein.

The elements and method steps described herein can be used in any combination whether explicitly described or not.

All combinations of method steps as used herein can be performed in any order, unless otherwise specified or clearly implied to the contrary by the context in which the referenced combination is made.

As used herein, the singular forms “a,” “an,” and “the” include plural referents unless the content clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference to the same extent as if each individual reference were specifically and individually indicated as being incorporated by reference. In case of conflict between the present disclosure and the incorporated references, the present disclosure controls.

It is understood that the invention is not confined to the particular construction and arrangement of parts herein illustrated and described, but embraces such modified forms thereof as come within the scope of the claims.

### EXAMPLES

### Example 1. Development of Bio-Based Films and Properties Thereof

### Summary

Bio-based films were tested for various optical, physical, and barrier properties. The films were generated in the forms of coating and standalone films. The coatings were tested on a variety of different hand sheets of differing material and internal sizing. They were tested for oil and grease resistance where a minimum coat weight was found with a TAPPI T 559 cm-22 Kit 12 resistance. A consistent minimum coat weight was determined by increasing the application rate and lowering the size of the rod. Testing determined that a coated sheet resulted in lower brightness, lower TAPPI opacity (Tappi T 425; see, e.g., the world wide web at imisrise.tappi.org/TAPPI/Products/01/T/0104T425.aspx), higher burst strength, higher burst index, higher folding endurance, lower air permeability, an increase in tensile strength, an increase in tensile index, an increase in tensile energy to break (TEB) (toughness), an increase in tensile stress at max load, an increase in percent elongation at max load, a slight decrease in the elastic modulus, and a decrease in the water vapor transmission rate (WVTR) of the sheet. The film strength and other properties seemed to be dependent on the ratios involved between the liquor extract and the microfibrillated fibers. It was determined that the higher the microfibrillated fiber content in the films, the higher the burst strength and tensile strength properties. TAPPI opacity did not seem to change with the addition level of microfibrillated fibers. All the films had full oil and grease resistance (Kit #12), and no WVTR and Oxygen Transmission Rate (OTR).

### Background

The present examples show the development and testing of bio-based films (coatings and standalone films) for their various physical, optical, and barrier properties. The coatings were tested on various grades of paper for oil and grease resistance, water vapor transmission rates, optimum coat weight, optical properties, and physical properties. Standalone films were created using a film casting method in which they were promptly tested for various physical properties also. The coatings for these tests were comprised of a soybean hull extract coupled with an acid extract with a pH of approximately 3. The standalone films were comprised of a mixture of the soybean hull liquor extract tested at various ratios. Throughout experimentation, various hand sheets were tested to determine which sheet would provide a viable coating with a low coat weight as well as great oil and grease resistance in the process. The utilization of rosin coupled with alum (aluminum sulfate) ultimately decreased the amount of coating needed to provide a Kit 12 oil/grease resistance. Once this was achieved, the coatings were tested for their physical properties to determine the effect of the coating on an individual sheet.

Although not required for the present invention, rosin and alum was incorporated into exemplary sheets to minimize the overall coat weight. A maximum of 20 pounds of rosin per 2000 pounds of fiber was used as per industry standard. Within the industry, water resistance against penetrating liquids is needed in a variety of paper products where sizing would ultimately be increasing the quality of a paper sheet. These ultimately can improve the appearance, the optical properties, and the printability of the sheets while also cutting down on costs on fibers. Rosin-alum sizing is specifically known as a form of internal sizing where alum and rosin are incorporated into the pulp mixture to increase certain properties in the paper. The rosin itself would fill in gaps within the paper increasing the water resistance while the alum would act as a charge neutralizer helping the rosin and fines to flocculate and attach to the fibers. The alum however is especially sensitive to the pH and worked best between pH 4.5 to 5.5. Therefore, steps were made during the process to ensure a range from 4.5 to 5 pH as the range (Arif Karademir, Ferhat Ozdemir and Sami Imamoglu, 2007. Effects of Alum-Rosin Sizing on the Properties of Some Wastepaper Grades*. Biotechnology, 6:148-152). It should be noted, however, that the use of rosin and alum is not a requirement. The films disclosed herein are less expensive than that of sizing agents and can potentially completely replace sizing if wanted with a slightly higher coat weight for oil and resistant papers.

Coatings and standalone films were a major focus of the experiments. These included bio-based films derived from soybean bull. Soybean hull is a major by-product of soybean processing. Some reports indicate that soybean hulls contain approximately 85.7% carbohydrates, 9% protein, 4.3% ash, and approximately 1% lipids with the carbohydrate fraction containing approximately 30% pectin, 50% hemicellulose, and 20% cellulose by dry weight. Other reports indicate that soybean hulls contain about 42.5% cellulose, about 19.3% hemicellulose, about 15.7% pectin, about 12.5% protein, about 3% lignin, about 5.5% minerals, and about 1.5% extractives by dry weight. Due to the high volume of carbohydrates within soybean hull, utilization of these fibers would be a cost effective as well as a viable option as an ingredient in coatings.

One goal of the tested films is the protection against oil and grease penetration. The protection against oil and grease is particularly important within the food industry to maintain the integrity of the food. Oil and grease resistance is especially important in protecting the packaged food from environmental elements while keeping oil and grease form leaking into the environment. (Kathan, Andrew, “Natural Polymer Barrier Coatings for Oil and Grease Resistance” (2018). Honors Theses. 3049). These coatings must be viable in a variety of ways to be used for food. They must be flexible and durable, lightweight to alleviate potential weight costs, have physical protection to the elements as well as being resistant to mold, function at various temperatures, and remain stable for long periods of time while maintaining its integrity over time.

Oil and grease resistance was tested using a procedure known as the Kit test (the test is run according to TAPPI Test Method T559). The Kit test describes the degree of repellence of oil and grease on paper, where Kit 1 describes the least aggressive reagents while 12 is the most aggressive reagent. The highest number that does not stain the sheet is referred to its Kit rating with 12 being the highest number (appliedpapertech.com/test-methods/grease-resistance/). Kit 12 was the standard the coating had to provide before moving onto physical testing where the Kit 12 oil was comprised of 22.5 mL of toluene and 27.5 mL of n-heptane. Once the basis was established for these coatings, physical testing was done to provide information about the effectiveness of these coatings while maintaining a minimum coat weight for a Kit 12 coating. Physical tests included the brightness tests, opacity tests, burst strength, burst index, folding endurance, air permeability, tensile strength, tensile index, tensile energy to break, tensile stress at max load, percent elongation at max load, elastic modulus, water vapor transmission rate (WVTR), and oxygen transmission rates (OTR). These physical properties can determine the effective durability of the coatings, a necessary factor in shelf life and stability of the product.

In terms of optical properties, brightness and the opacity of the coatings may not provide functional properties of the coating, but they still should be accounted for due to a market reliant on the visual aspect when purchasing goods. Brightness refers to the percentage of reflectance of blue light at the wavelength of 457 nm, while the opacity refers to how much light is kept away from passing through the sheet. Opacity of the samples were measured according to Tappi test method T 425, While brightness measurements were made according to Tappi test method T 452. Brightness can be improved by having fillers and/or pigments in the paper before coating if needed.

The physical properties referred to earlier include the use of burst strength and the burst index. The burst strength refers to the amount of pressure the paper can tolerate before rupturing. The burst index refers to the burst strength divided by the grammage (the weight per unit area). This element of testing is an important aspect in determining the durability of the film as well as the resistance to compressive forces. Tappi test method T 403 was used in the determination of burst strength properties. Folding endurance also is an effective measure of resistance to creases and bends within the structure. Tappi test method T 511 was used in the determination of folding endurance. Tensile strength and the tensile index refer to the force required to rupture a strip of paper and the tensile force divided by the grammage, respectively. These can be used as an indicator of flexibility as well as durability to tensile forces. The tensile energy at break (TEB) is described by the area under the stress-strain curve where the stress is the force exerted per unit cross sectional area on an object, and the strain refers to the extension per unit original length of the object. Tappi test method T 404 was used in the determination of tensile properties. Air permeability test method is used to measure the air resistance of approximately 6.45 sq. cm. (1 sq. in.) circular area of paper using a pressure differential of 1.22 kPa. This is an effective measure of seeing how the film protects against outer elements. Tappi test method T 460 was used in the air permeability property. The water vapor transmission rate (WVTR) measures the passage of water vapor through a sub a substance. ASTM E398 standard test method was used in the determination of WVTR. The water vapor transmission rate, under known and carefully controlled conditions, may be used to evaluate the vapor barrier qualities of a sheet. Oxygen transmission rates were measured by the ASTM D3985 test method. This test method covers a procedure for determination of the steady-state rate of transmission of oxygen gas through plastics in the form of film, sheeting, laminates, coextrusions, or plastic or film coated papers or fabrics. It provides for the determination of (1) oxygen gas transmission rate (OTR), (2) the permeance of the film to oxygen gas (PO2), and (3) oxygen permeability coefficient (P′O2) in the case of homogeneous materials.

### Methods

To generate a liquor extract from soybean hull (SBH), 100 BD grams of SBH was combined with 516 mL of water to allow for a consistency of approximately 15% w/w (Liquor to solid ratio of 6). This solution was then brought to a pH of 3 with the addition of HCl. This was then transferred to a heat resistant sealing bag and put into a hot water bath with a temperature of approximately 96.5° C. and heated for approximately 30 minutes. After the contents of the soybean hull reached about 95° C. and above, a timer was started and heating in the water bath was continued for 60 minutes. This heating allowed the components of the soybean hull to solubilize. The contents of the bag were then placed in a centrifuge at a speed of approximately 9000 rpm to separate the liquor from the solids. This liquor would be used as the oil and grease resistant coatings and in the films as the SBH extract liquor.

Standalone films comprised of SBH liquor extract alone and microfibrillated SBH (MFSBH) and SBH extract blends at different proportions were tested. MFSBH were produced first by treating ground SBH with HCL at pH: 3.0 in aqueous medium (Liquid/solid=6) and 96.5° C. for 1 hour and the resultant product was passed through microfluidizer as a whole for 10 times with 10,000 psi chamber pressure. Final product is the MFSBH and is used as coatings and in some of the films. After pouring each solution into each petri dish, the water is evaporated allowing the films to form and be tested.

Recycled and Kraft hardwood sheets were created with varying amounts of alum and rosin. Standard handsheets were made by Tappi test method, T 205. Briefly, since a hand sheet is approximately 1.2 grams dry, the amount of fiber used was equivalent to the number of sheets used (plus one to account for losses). This resulted in the total dry weight of the number of sheets. This was then divided by the solids content of the prepped fiber resulting in the total amount of wetted fiber used. Ultimately, a consistency of 0.3% w/v was used. The consistency was determined by having the dry weight of fiber over the total weight of the fiber solution. This total weight was x where x was subtracted by the weight of wetted fiber to determine the amount of water to be added to the solution to achieve a consistency of 0.3%. Before creating this solution, the fiber was prepped again using the provided disintegrator for approximately 10 minutes. From there, the disintegrated fibers were poured into a large mixing bucket where a consistency of 0.3% was achieved by adding water. Hand sheets would be created by taking 400 mL of the solution and pouring it into a sheet making apparatus and mixing. For pulps with the addition of alum and rosin, the pulp mixture was first reduced to a pH of approximately 4.5 to 5. From there, rosin was added along with alum (1.5 times the amount of rosin) to the mixture. The mixture was mostly comprised of 20 lbs rosin per 2000 lbs of fiber with 30 lbs of alum being added per 2000 lbs of fiber. A balance was set up to determine how much rosin was needed per 1.2 grams of fiber based on the provided ratio above. From there, rosin mixtures were created where the solids content was reduced to a lower percentage such as 1% to 5%. From there another balance was done to determine how much rosin mixture was to be added for the 1.2-gram sheet. After adding all the components into the column, as stated before, the column was mixed and allowed to settle for about five seconds. From there, the container was then drained to form a handsheet. The column was then unhinged where a new blot was placed on the wet sheet followed by an old blot and a couch plate on top. This was rolled five times before removing the sheet to be pressed. These handsheets were subsequently conditioned by Tappi test method, T 402 at 23° C. and 50% humidity.

After conditioning, sheets were placed upon a coating machine and taped to the surface. These sheets were then subject to different sized rods at differing metering speeds to determine the optimal coat weight of the sheet. Coats were done in series where the rod was placed on the machine with the provided weight being applied to the top of the rod. The liquor was then placed at the base of the rod in excess to ensure proper coating of the sheet. After setting the selected rod and selecting the speed of rolling, the machine was allowed to coat the sheet, and from there the rod was then cleaned and placed back at the base of the machine with the weight being applied on top. The sheet was then dried using a hot air dryer. This was then repeated a select number of times before removing the tape and the sheet. This was then tested for the coat weight by cutting the sheet into easily determinable dimensions where the sheet was then measured. The grammage was then determined for the sheet which was compared to the grammage of the uncoated sheet which was done prior to coating the sheet. The difference between the grammage of the uncoated sheet and the coated sheet was determined to be the coat weight of the coating.

Afterwards, the Kit number was determined by Tappi test method T 559. A drop of kit number test solution is dropped on the surface of the tested coated surface. 15 seconds after the drop was applied to the coating, the drop was wiped, and coating was checked to determine if staining occurred. If staining occurred, a lower Kit number was measured. If no staining occurred, a higher Kit number was measured until staining occurred. The highest number without staining was the Kit number for the sheet. The speed and type of rod used then depended on the effectiveness of the coat where a Kit 12 number was then considered. The rod size was changed along with the speed to allow for a smaller coat weight to occur. This was done until the minimum coat weight was found along with a Kit 12 number.

The 20-lb rosin sheets were then made again to allow testing to occur. 20-lb rosin recycle sheets and 20-lb rosin hardwood sheets were then created in excess with half of them coated to determine the physical effectiveness of the sheets at a minimum coat weight resulting in a Kit 12 oil and grease resistance. The following sheets were then tested following TAPPI standards T220. First the weight of 5 sheets coated and uncoated are weighed and averaged then divided by the number of sheets to determine the weight of one sheet. This was followed by the determination of the average area of each sheet. From there each sheet was determined for grammage using Tappi test method, T410, caliper of the sheets was measured. The caliper of sheets was measured at 10 random points where the values were then averaged and divided by the number of sheets to determine the average thickness of one sheet. Next, Technidyne Micro S5 was used to determine the brightness and opacity of the sheets. Brightness was tested by placing the sheet facing the brightness indicator. The opacity was determined by placing the sheet of the light source and following the instructions on the machine. This was done for all the sheets until all the TAPPI opacities were measured. The sheets were placed in a Gurley tester to determine the air permeability of the sheet by Tappi test method, Tappi T 460. Briefly, the sheet was placed polished side up. The piston was then brought up until it was latched in place. From there, the sheet was tightened to allow a seal to form on the sheet. This was done for 100 mm where the seconds were then counted to be calculated for permeability. These values were then averaged to determine the average permeability of the sheets. For the destructive tests, the sheets were prepared so the sheet would have one semi-circle with an edge 63 mm in length. Two middle portions were 15 mm in length, resulting in another semi-circle for burst testing. Although tearing was not covered, the sheets were then used for the burst testing where the semicircle was placed on the machine ensuring the glossy or coated side down. This was done twice on a single semicircle and repeated for each handsheet. The values were then averaged to determine the average burst strength of the sheet. Folding allowed the strip to be attached to two ends of the apparatus with a kg of load being applied to the strip. The machine would then fold the strips until a break would occur. These values would also be averaged. The tensile test uses the same strips where each side of the strip is attached to the machine where the machine automatically measures the tensile properties of the strip. These tests were also done in a similar manner to the standalone films with some minor differences to account for less data needed.

The water vapor transmission rate was determined using specialized machinery using ASTM standard, ASTM E398-13 for coated and uncoated handsheets as well as standalone films.

Oxygen gas transmission rates of the films were measured with specialized machinery according to ASTM D3985-05.

Where indicated (see the descriptions of the drawings), resulting data were analyzed by one-way ANOVA using the general linear model. If there was a significant F-test, subsequent comparisons of treatment means were determined using the Dunnett's multiple range test. Differences were considered significant at the 0.05 probability level. All statistics were performed using GraphPad Prism 9 (San Jose, CA, USA).

Standalone films were generated using a 15-cm diameter petri dish using a method called cast filming. Here differing ratios of microfibrillated SBH after acid treatment were added with the soybean hull liquor extract under agitation with a magnetic stir for approximately 4 hours. Standalone films were generated by blending differing ratios of (MFSBH) and the SBH liquor extract. These were done in ratios of 10%, 20%, 40% w/w addition levels of MFSBH (into soybean hull liquor extract) and were later tested. MFSBH were produced first by treating ground SBH with HCL at pH: 3.0 in aqueous medium (Liquid/solid=6) and 96.5° C. for 1 hour and the resultant product was passed through microfluidizer 10 times with 10,000 psi chamber pressure. Soybean hull extract liquor was produced by first treating finely ground soybean hull with acid at pH 3.0 in aqueous medium with a liquor to solid ratio of 6 for 1 hour at 95° C. Liquor fraction, then was separated from the solid fraction by filtration and used in the film production. Same testing methods that were discussed in paper coating applications were used in the evaluation of stand-alone films.

### Results

The objective of these examples was the development and testing of bio-based films (coatings and standalone films) for various physical, optical, and barrier properties. In terms of coating applications, the coatings were tested for oil and grease resistance, WVTR, physical properties, and optimum coat weight. When determining the optimum coat weight, several tests were done to determine the optimum coat weight. Initially, trails began by creating hand sheets not requiring the use of rosin and alum. The absence of internal sizing resulted in significantly higher coat weights. The coat weight for the 20-lb rosin recycled hand sheets was found to approximately be 12.483 g/m² with a difference of 2.45 g/m² if the recycled sheets were not internally sized with rosin, indicating the importance of sizing. The 20-lb hardwood variant had an optimal coat weight of 13.144 g/m².

When testing the physical properties of the coatings, the first thing done was to determine the grammage of each sheet. The sheets were divided into 20-lb rosin uncoated recycle paper, 20-lb rosin coated recycle paper, 20-lb rosin uncoated hardwood paper, and 20-lb rosin coated hardwood paper. The uncoated recycle sheet was found to have a grammage of 60.43 g/m² while the coated variant was found to be 73.71 g/m². This results in a coat weight of 13.28 g/m² for the recycled paper. This was close to the intended range of 12.5 grams to 13.1 grams as stated above. Moving on to the hardwood, the grammage was found to be 63.75 g/m² while the coated version was found to be 74.94 g/m². This results in a coat weight of 11.19 g/m².

The thickness was measured and found to be 0.1096 mm for the uncoated recycled sheet while the coated sheet was found to be 0.123 mm. This indicated that the thickness of the overall coat that resulted in a Kit 12 oil resistance was about 0.0134 mm for the recycled sheet. The thickness of the uncoated and coated hardwood sheets was found to be 0.0849 mm and 0.0954 mm, respectively. This meant that the thickness for the hardwood variant was 0.0105 mm.

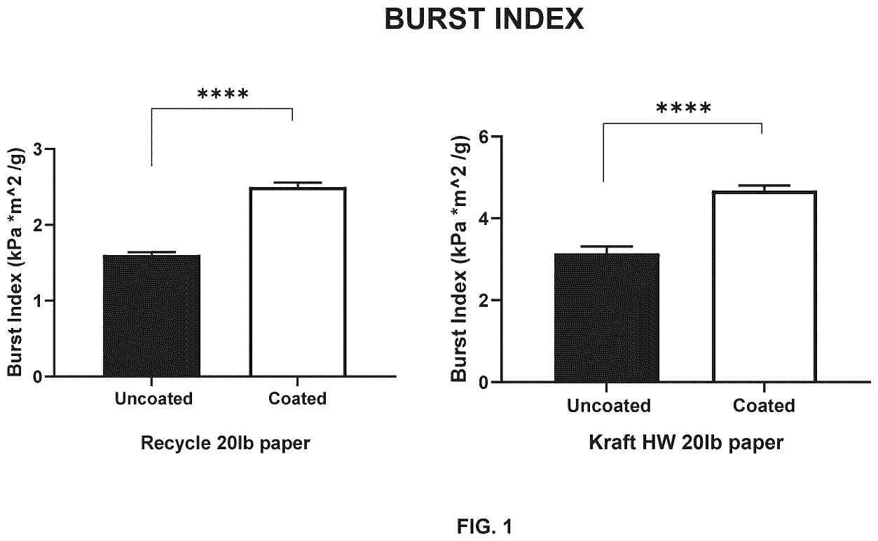

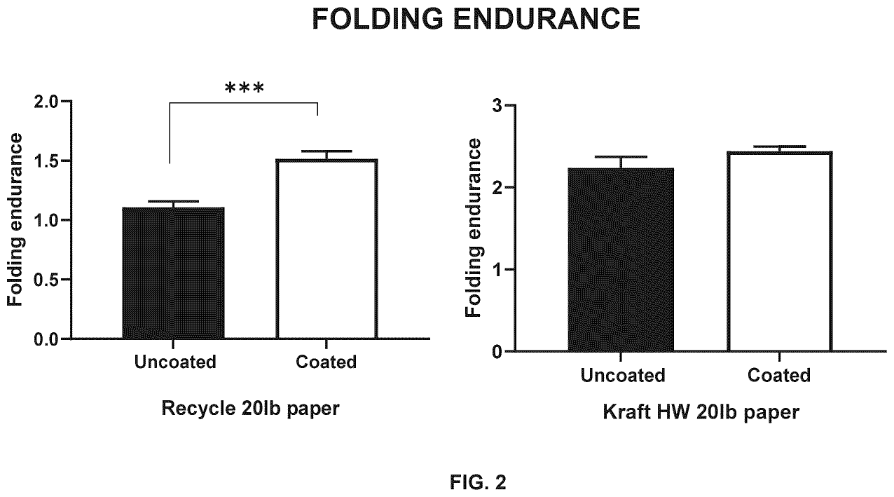

Moving onto the optical properties, the brightness and the opacity were measured for each uncoated and coated sheet. Results are seen in FIGS. 1 and 2. The brightness of the uncoated and coated recycled sheets were 51.26 and 38.84, respectively, on a scale between 0 and 100. The brightness of the uncoated and coated hardwood was 24.72 and 20.17, respectively, on a scale between 0 and 100. There is a greater decrease in the brightness with the recycled sheet rather than the unbleached kraft hardwood sheets. The opacity was shown to decrease with the coated sheets, most likely due to the coating providing an extra layer to block light from passing through. The opacity for the recycled sheets was 93.64% uncoated and 90.23% coated. The opacity for the hardwood sheets was 83.97% coated and 81.01% coated. This indicates that the coatings were relatively minor in affecting the overall opacity of both sheet types.

The burst strengths of the uncoated and coated recycle pulp sheets were 96.9 kPa and 184.1 kPa, respectively. The burst strengths of the uncoated and coated hardwood pulp sheets were 200 kPa and 351 kPa, respectively. To normalize the burst strength values, the burst index was determined. Burst index results are shown in FIG. 1 and Table 1. Burst index values increased approximately 1.5 times with coating on both recycled and unbleached hardwood kraft sheets. This increase was less pronounced with kraft wrapping paper after coating (Table 1). The uncoated recycled sheet had a value of 1.60 (kPa*m\hat{ }2/g) while the coated sheet had a value of 2.50 (kPa*m\hat{ }2/g). The kraft hardwood uncoated sheet had a value of 3.16 (kPa*m\hat{ }2/g) while the coated sheet had a value of 4.68 (kPa*m\hat{ }2/g). The burst index values for kraft wrapping paper was 4.65 (kPa*m\hat{ }2/g) and 4.79 (kPa*m\hat{ }2/g), for uncoated and coated sheets, respectively.

Folding endurance results are shown in FIG. 2 and Table 1. The folding endurance was 1.12 for the uncoated recycle sheet and 1.53 for the coated recycle sheet. The folding endurance uncoated unbleached hardwood kraft sheet was found to be 2.32 for the uncoated unbleached hardwood kraft sheet and 2.45 for the coated unbleached hardwood kraft sheet. Folding endurance of the recycled sheets were increased by about 37%, while the unbleached hardwood kraft sheets were increased by about 6%. Coating had more increasing effect on the folding endurance of intrinsically weaker recycled sheets by enhancing fiber-fiber bondings in the sheets.

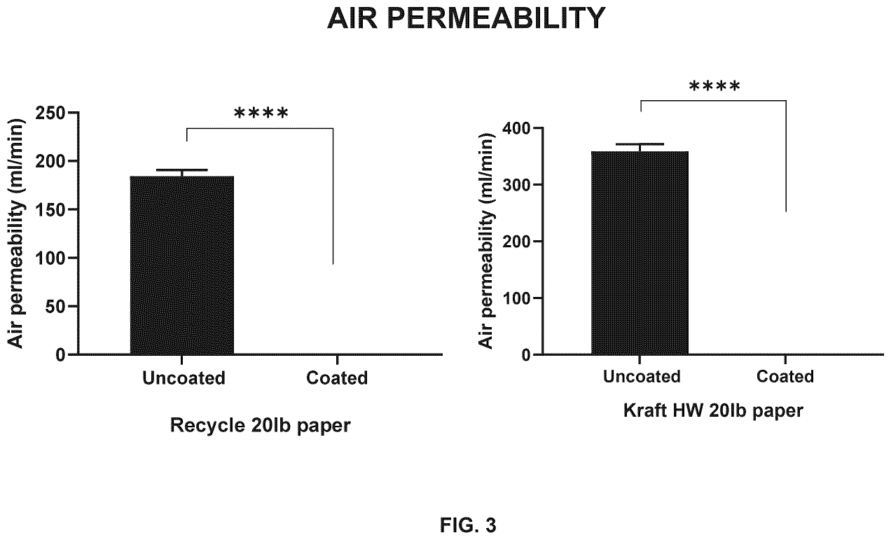

Air permeability tests were executed to determine the effect of the coatings on the barrier properties of the standard handsheets. Results are shown in FIG. 3 and Table 1. The air permeability was considered infinite with no visual change being made for days while coated sheets were placed in the apparatus. The unbleached hardwood kraft sheets were found to be lesser in air permeability with a value of 16.91 seconds/100 ml for the uncoated sheet compared to 32.94 seconds/100 ml for the uncoated recycled sheet. The coated recycled sheet and the hardwood kraft sheet were both impermeable to air. Air permeability of kraft wrapping sheets were also significantly reduced from 16.74 seconds/100 ml with uncoated sheets to 8380 seconds/100 ml of coated sheets.

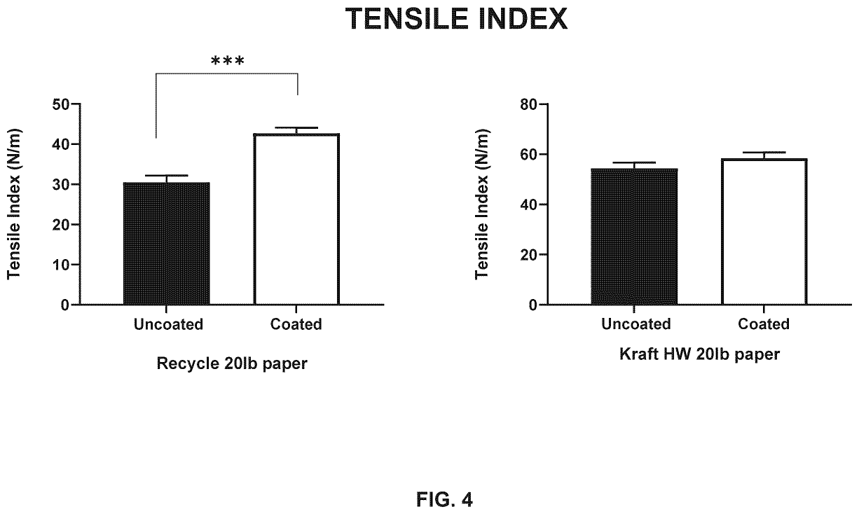

The tensile strengths of the uncoated and coated recycled sheets were 1845.194 N/m and 3150.63 N/m, respectively. The tensile strengths of the uncoated and coated hardwood were 3470 N/m and 4383.656 N/m, respectively. These values were normalized using the tensile index. As shown in FIG. 4 and Table 1, the tensile index for the uncoated recycled sheet was 30.53 Nm/g, while the coated recycled sheet was 42.74 Nm/g. The value for the uncoated hardwood was 54.43 Nm/g, while the value for the coated hardwood sheet was 58.49 Nm/g. Based on the tensile index, it is shown that the recycled paper was affected more by the coating rather than the hardwood. This could also be attributed to the tensile strength being directly dependent on the fiber-to-fiber bonds within the strip. Due to the higher fiber-to-fibers bonds within the hardwood, it is expected to have a higher tensile strength value as well as a higher tensile index value. Although the coating does improve the tensile properties of each sheet, there seems to be a feasible limit to how far the coating itself can stretch itself with its limit nearing the properties of the hardwood sheet. This would explain the decreased effect of the coating upon the hardwood sheet which is more reliant on the fiber-to-fiber bonds rather than the coating itself. As in the folding explanation, the coating seems to act as a reinforcement to the bonds. The recycled sheet is greatly affected by the coating because its tensile properties work to aid the sheet where the properties coating vastly outmatch the tensile properties of the recycled sheet. The tensile index for kraft wrapping paper is also increased slightly after coating. The tensile index values were 46.5 Nm/g and 47.7 Nm/g for uncoated and coated sheets, respectively.

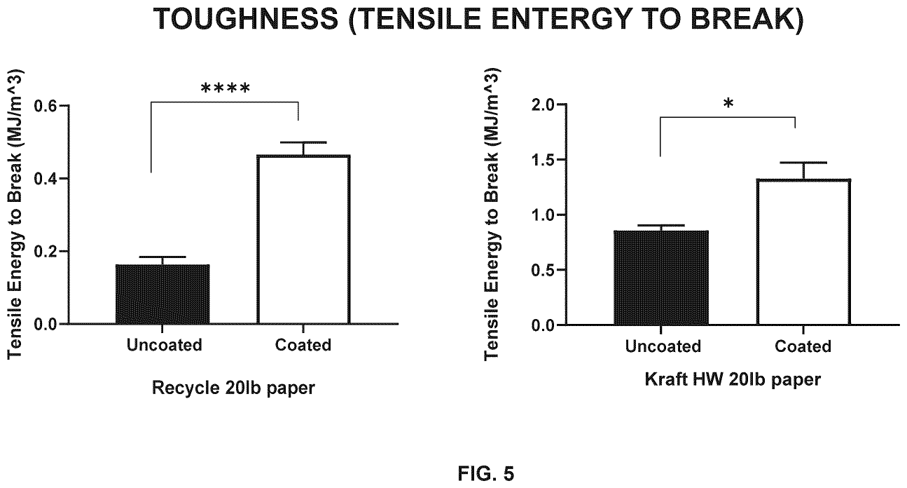

Tensile energy to break (TEB) (toughness) results are shown in FIG. 5 and Table 1. The TEB was a measure of the area under the curve for a stress vs strain plot. The stress ratio of the force being applied over the cross-sectional area, with the strain being the deformation that occurs due to the stress. The TEB is expressed in MJ/m\hat{ }3. The values for TEB are 0.164 MJ/m\hat{ }3 for uncoated recycle, 0.466 MJ/m\hat{ }3 for coated recycle, 0.858 MJ/m\hat{ }3 for unbleached hardwood kraft uncoated, and 1.328 MJ/m\hat{ }3 for unbleached hardwood kraft coated. This toughness is the ability to absorb energy before fracture. Like other tensile properties, this seemed to directly be affected by fiber-to-fiber bonds of the sheets as well as the tensile properties present within the coating. Coating intrinsically weak recycled sheets improved their toughness by 184%, while this increase was about 55% with unbleached hardwood kraft sheets. Combined with tensile strength, high toughness (high TEB, high ductility) is very important in packaging grade papers indicating high load carrying capacity without sudden failures/tears with stretching ability. Coating papers with the coatings of the invention improve both tensile strength and toughness properties of the films significantly. The tensile stress at max load values were 16.836 MPa for the uncoated recycled sheet, 25.61488 MPa for the coated recycled sheet, 40.906 MPa for the uncoated hardwood, and 45.95 MPa for the coated hardwood. The percent elongation at max load was 1.436% for the uncoated recycled sheet, 2.642% for coated recycled sheet, 2.912% for the uncoated hardwood sheet, and 4.006% for coated hardwood sheet.

Water vapor transmission rate (WVTR) results are shown in Table 1. WVTR is a measure of the passage of water vapor through a film. The coatings decreased the WVTR of the sheets. The WVTR was 135.61 g/m² day for the uncoated recycled sheet, 123.2598 g/m² day for the coated recycled sheet, 143.64 g/m² day for the uncoated hardwood sheet, and 123.41 g/m² day for the coated hardwood sheet.

The coatings of the invention improve strength properties along with barrier properties with full oil and grease resistance of sheets that are coated with them. This makes papers coated with the coatings of the invention very suitable for packaging applications (i.e. food packaging).

A summary of the coating properties outlined above is provided in Table 1.

TABLE 1
Properties of coated papers compared to uncoated papers.

| | Recycled Paper | | Hardwood Kraft Pulp | |
|---|---|---|---|---|
| | | Coated | | Coated |
| | Uncoated | (wgt: 13.27 g/m²) | Uncoated | (wgt: 11.19 g/m²) |
| Oil and Grease | 0 | 12 | 0 | 12 |
| Resistance (Kit #) | | | | |
| Water Vapor | 135.21 | 123.26 | 143.64 | 123.41 |
| Transmission | | | | |
| Rate | | | | |
| (g/m² day) | | | | |
| Air | 32.94 | Not air | 16.91 | Not air |
| Permeability | | permeable | | permeable |
| (seconds per 100 mL) | | | | |
| Tensile Index | 30.53 | 42.74 | 54.43 | 58.49 |
| (Nm/g) | | | | |
| Tensile Energy | 0.164 | 0.466 | 0.858 | 1.328 |
| to Break | | | | |
| (Toughness) | | | | |
| (MJ/m\hat{ }3) | | | | |
| Burst Index | 1.6 | 2.5 | 3.16 | 4.68 |
| (kpam²/g) | | | | |
| Folding | 1.12 | 1.53 | 2.32 | 2.45 |
| Endurance | | | | |
| (log10) | | | | |

Along with paper coatings, several standalone films were also tested for their various physical and optical properties as shown in Table 2. The resulting films were semi-transparent, flexible, self-standing, and strong. All the produced films had full oil and grease resistance (Kit #12), and 0 water vapor transmission rate, and 0 oxygen transmission rates. The grammage for the standalone films was measured. The films made from 100% soybean hull (SBH) acid extract liquor had a grammage of 392 g/m². The 10% MFSBH films bad a grammage of 375 g/m², and the 20% MFSBH films had a grammage of 392 g/m² and the 40% MFSBH films had a grammage of 383 g/m² These grammages are important later in normalizing the measured values.

As shown in Table 2, the standalone films were tested for opacity. The TAPPI opacity was found to be 20.4 for the films from 100% soybean hull extract liquor, 19.64 for 10% MFSBH, 23.06 for 20% MFSBHM and 20.66 for 40% MFSBH. Addition of MFSBH into the acid extract SBH liquor did not affect opacity of the resultant films significantly.

The tensile strengths of the films as shown in Table 2 were found to be 0.54 kN/m for the films from 100% soybean hull liquor extract, 1.21 kN/m, 2.54 kN/m, 2.84 kN/m for 10%, 20%, and 40% MFSBH addition levels, respectively. Tensile strength of the films are increased as higher addition of MFSBH are added into the liquor soybean hull extract.

Burst strength of the standalone films is shown in Table 2. The burst strengths of the films were 195.26 kPa for 100% liquor extract of soybean hull, 282.69 kPa, 429.96 kPa, and 453.26 kPa, for 10%, 20%, and 40% MFSBH addition levels, respectively. Similar to tensile strength, burst strength of the films increased as the percentage of the MFSBH addition was increased in the films.

TABLE 2
Films made from soybean hull liquor extracts and
blends of soybean hull liquor extracts and microfibrillated
soybean hull material after treatment.

| | | Tensile | Burst |
|---|---|---|---|
| | Opacity | Strength (kN/m) | Strength (kPa) |
| SBHAE | 20.4 | 0.54 | 195.26 |
| SBHAE + 10% MFSBH | 19.64 | 1.21 | 282.69 |
| SBHAE + 20% MFSBH | 23.062 | 2.5424 | 429.96 |
| SBHAE + 40% MFSBH | 20.666 | 2.84 | 453.26 |

### Conclusions

The coatings described herein provided full resistance to oil and grease (Kit #12) lower brightness, lower TAPPI opacity, increased tensile strength, increased burst index, increased folding endurance, decreased air permeability allowing no to little air to pass, increased tensile strength and index, increased toughness, and decreased allowing no to little WVTR for the tested sheets.

The film strength and properties seemed to be dependent on the ratios involved between the liquor extract and the microfibrillated soybean hull cellulose. It was determined that the higher the microfibrillated soybean hull content in the films, the higher the burst strength and tensile strength properties. TAPPI opacity did not seem to change with the addition level of microfibrillated soybean hull. All the films had full oil and grease resistance (Kit #12), and no WVTR and OTR.

### Example 2. pH, Temperature and Treatment Time Variations for Preparing Coatings

Paper coatings were made from soybean hulls as described in Example 1 except that pH, temperature, and treatment time in generating the liquor extract were varied. The coatings were applied to unbleached kraft wrapping paper. Results are shown in Table 3.

TABLE 3
Coat properties at different pH, temperature, and treatment times.

| pH | Temperature (° C.) | Time (min) | Kit No. | Coat Weight (g/m²) |
|---|---|---|---|---|
| 3 | 80 | 30 | 12 | 12.52 |
| 3 | 80 | 60 | 12 | 12.28 |
| 3 | 80 | 90 | 12 | 16.39 |
| 3 | 95 | 30 | 12 | 19.10 |
| 3 | 95 | 60 | 12 | 12.25 |
| 3 | 95 | 90 | 12 | 16.95 |
| 2 | 80 | 30 | 12 | 22.84 |
| 2 | 80 | 60 | 12 | 24.45 |
| 2 | 80 | 90 | 12 | 26.16 |
| 2 | 95 | 30 | 12 | 27.97 |
| 2 | 95 | 60 | 12 | 40.02 |
| 2 | 95 | 90 | 12 | 38.25 |

### Example 3. pH and Kit Number Variations

Paper coatings were made from soybean hulls as described in Example 1, except that the pH and coat weights were varied. The coating were applied to unbleached kraft wrapping paper, and Kit numbers were determined. The treatment temperature was 95° C., and the treatment time was 60 minutes for all the coatings. Liquor to solid ratios were 6 for all of the treatments. Results are shown in Table 4. pH 3 was found to provide maximum oil and grease resistance (Kit #12) with minimum coat weight on the coated sheets.

TABLE 4
Soybean hull coat properties at different pH and Kit numbers.

| pH | Kit No. | Coat Weight (g/m²) |
|---|---|---|
| 3 | 5 | 6.5 |
| 3 | 6 | 7.7 |
| 3 | 12 | 9.3 |
| 3.5 | 6 | 10.11 |
| 3.5 | 8 | 9.21 |
| 3.5 | 9 | 12.05 |
| 3.5 | 12 | 14.52 |
| 4 | 6 | 9.18 |
| 4 | 8 | 9.42 |
| 4 | 10 | 14.44 |
| 5 | 3 | 8.59 |

### Example 4. Feedstock Variations

Paper coatings were made as described in Example 1, except that sugar beet pulp was used as a feedstock in place of soybean hulls, and the sugar beet pulp. The coatings were applied to unbleached kraft wrapping paper. The coat weight sufficient to provide a Kit number of 12 was 22.03 g/m².

### EXAMPLE 5. UNBLEACHED KRAFT WRAP PAPER

Course ground soybean hull was finely ground and treated with acid (HCl, pH 3) in aqueous medium at elevated temperature (95° C.) for 1 hour. The resultant product was centrifuged to separate the liquor phase from the solid phase. The liquor phase was coated on unbleached kraft wrap paper to enhance oil and grease resistance and air barrier properties. The basis weight of the wrap paper was 90 g/m². The Kit # of the uncoated paper for oil and grease resistance was 0. The Kit # of the coated paper for oil and grease resistance was 12 with an average coat weight of about 9 g/m². Strength properties of the coated unbleached kraft wrap paper are shown in Table 5. All the strength properties are improved after coating the sheets with the coatings of the invention.

TABLE 5
Strength properties of coated unbleached kraft wrap paper.

| | Uncoated | Coated |
|---|---|---|
| Tensile Strength (kN/m) | 4.65 | 4.79 |
| Burst Strength (kg/cm²) | 3.42 | 3.79 |
| Folding Endurance (log10) | 2.26 | 2.44 |

Air permeability properties of the coated unbleached kraft wrap paper are shown in Table 6.

TABLE 6
Air Permeability properties of coated unbleached kraft wrap paper.

| | | Air Permeability (sec/100 mL) |
|---|---|---|
| Uncoated | Side 1 | 17.16 |
| | Side 2 | 16.32 |
| Coated | Coated Side | 8380 |
| | Uncoated Side | 418 |

Coat weights for various Kit numbers for the coated unbleached kraft wrap paper are shown in Table 7.

TABLE 7
Coat weight versus Kit number for
coated unbleached kraft wrap paper.

| Coat Weight (g/m²) | Kit # |
|---|---|
| 9 | 12 |
| 7.7 | 6 |
| 6.5 | 5 |

### Example 6. Inclusion of Microfibrillated Soybean Hulls in Films

Course ground soybean hull was finely ground and treated with acid (HCl, pH 3) in aqueous medium at elevated temperature (95° C.) for 1 hour. The resultant product was further treated with a microfluidizer to micro-fibrillate the product as a whole. Standalone films and paper coatings were prepared as described in Example 1. The formed standalone films had full oil and grease resistance (Kit #12) and coatings had enhanced oil and grease resistance and air barrier properties depending on the coat weight. At higher coat weights (more than 25 grams/cm²) a Kit number of 12 was achieved for the oil and grease resistance, while the barrier property was significantly enhanced (several thousands of seconds per 100 ml air). Coat weights for various Kit numbers for the coated paper are shown in Table 8.

TABLE 8
Coat weight versus Kit number for coated paper.

| Coat Weight (g/m²) | Kit # |
|---|---|
| 10.79 | 4 |
| 13.48 | 6 |
| 19.16 | 11 |

### Example 7. Film Applications

The films provided in the present examples are 100% plant based, safe, flexible, edible, and non-hazardous products that are fully resistant to oil and grease in standalone film form or when coated on hydrophilic substrates such as paper (including paperboard) and other packaging substrates. The films offer options for the pulp, paper, and packaging industries to replace environmentally persistent oil and grease resistant barriers including fluorochemicals and extruded polyethylene as ecofriendly alternatives. The films have excellent air barrier properties which are very important for packaging in enhancing the shelf life of food matter. The films also enhance the strength properties of the paper to which they are applied. The standalone films have good strength properties and can be used alone in various applications, including packaging. The feedstock (e.g., soybean hull) is currently a waste abundantly available at a low cost in USA. The production of the films is inexpensive, requiring only a few processing steps. The production is commercially viable, scalable, and requires only commercially available equipment. It generates no effluent or waste. The exemplary feedstock is plant based and can be fully utilized or integrated with other processes to produce a number of additional products such as micro-nano fibrillated fibers, dissolving pulp, etc. The films are edible and eco-environmentally friendly.

1. A method of making a film, the method comprising:
treating a feedstock comprising pectin-containing and protein-containing biomass with an aqueous acidic solution at a pH, at a temperature, and for a time sufficient to yield a mixture containing a solid phase comprising biomass solids and a liquor in liquid phase comprising partially dissolved biomass, wherein acid within the aqueous acidic solution is added exogenously or is formed in situ;
generating a forming fluid with the liquor; and
generating the film from the forming fluid.

2. The method of claim 1, wherein the biomass comprises at least 4% w/w pectin and at least 5% w/w protein.

3. (canceled)

4. The method of claim 1, wherein the biomass comprises less than 10% w/w lignin.

5. The method of claim 1, wherein the biomass comprises soybean-hull biomass, fruit or vegetable pomace, sugar beet pulp, citrus biomass, rapeseed biomass, or any combination thereof, wherein the biomass is in particle form having a US mesh size of 8 or finer.

6. (canceled)

7. The method of claim 1, wherein the pH is from 1 to 5, the temperature is from 65° C. to 100° C. and the time is at least 20 minutes.

8-9. (canceled)

10. The method of claim 1, wherein the generating the forming fluid comprises separating the liquor from the solid phase to generate a separated liquor and generating the forming fluid with the separated liquor.

11. The method of claim 10, wherein the forming fluid comprises the separated liquor in an amount of at least 40% w/w.

12. The method of claim 1, wherein the generating the forming fluid comprises comminuting the solid phase to generate a comminuted solid phase and including the comminuted solid phase in the forming fluid.

13. The method of claim 1, wherein the generating the forming fluid comprises comminuting the solid phase in the mixture to generate a comminuted mixture and generating the forming fluid with the comminuted mixture.

14. The method of claim 13, wherein the forming fluid comprises the comminuted mixture in an amount of at least 20% w/w.

15. The method of claim 1, wherein the generating the film comprises generating a standalone film.

16. The method of claim 15, wherein the film has a grammage of from 30 g/m² to 600 g/m².

17. The method of claim 1, wherein the generating the film comprises coating a substrate with the forming fluid to generate a coated substrate.

18. The method of claim 17, wherein the film has a grammage of from 4 g/m² to 30 g/m².

19. The method of claim 17, wherein the substrate comprises paper such that the coated substrate is coated paper.

20. The method of claim 19, wherein the paper prior to the coating has a TAPPI T 559 Kit Number less than 6, and wherein the coated paper has a TAPPI T 559 Kit Number greater than 6.

21. (canceled)

22. The method of claim 1, wherein the film has an air permeability value greater than 200 s/100 mL.

23. The method of claim 1, wherein:
the biomass comprises at least 4% w/w pectin;
the biomass comprises at least 5% w/w protein;
the biomass comprises less than 10% w/w lignin;
the pH is from 1 to 5;
the temperature is from 65° C. to 100° C.;
the time is at least 20 minutes;
the generating the forming fluid comprises separating the liquor from the solid phase to generate a separated liquor and generating the forming fluid with the separated liquor;
the forming fluid comprises the separated liquor in an amount of at least 40% w/w;
the generating the forming fluid comprises comminuting the solid phase in the mixture to generate a comminuted mixture and generating the forming fluid with the comminuted mixture;
the forming fluid comprises the comminuted mixture in an amount of at least 20% w/w;
the generating the film comprises coating a substrate with the forming fluid to generate a coated substrate;
the film has a grammage of from 4 g/m² to 30 g/m²;
the substrate comprises paper such that the coated substrate is coated paper;
the paper prior to the coating has a TAPPI T 559 Kit Number less than 6;
the coated paper has a TAPPI T 559 Kit Number greater than 6; and
the film has an air permeability value greater than 200 s/100 mL.

24. A coated substrate made from the method of claim 17.

25. A film made from the method of claim 1.
